(19) United States
(12) Patent Application Publication
(10) Pub. No.: US 2007/0295627 A1
(43) Pub. Date: Dec. 27, 2007

(54) TOOLBOX WITH PREVIEW WINDOW

(76) Inventor: Chih-Ching Hsieh, Taichung Hsien (TW)

Correspondence Address: Chih-Ching Hsieh, 235 Chung - Ho, Box 8-24, Taipei, 235, TW

(21) Appl. No.: 11/852,330

(22) Filed: Sep. 10, 2007

Related U.S. Application Data
(63) Continuation-in-part of application No. 11/368,007, filed on Mar. 6, 2006, now abandoned.

(51) Int. Cl. B25H 3/00; B65D 6/06

(52) U.S. Cl. 206/372; 220/812

(57) ABSTRACT

A toolbox with at least one preview window comprises a body having a receiving portion for receiving at least one tool; and at least one preview window for viewing objects in the receiving portion. The preview window can be installed at a front plate of a drawer or a lateral surface of the body or a top surface of the body. The receiving portion may be a single space or a plurality of sub-spaces which are spaced by at least one spacer. A bottom of the body has at least one wheel. Furthermore, a lower side of the front plate of each drawer may be formed with a slot. The user can pull the drawer by inserting a hand into the slot.

The present invention is a continuation in part of U.S. Pat. No. 11/368,007 which is assigned and invented to the applicant and inventor of the present invention, and thus the contents of the invention, U.S. Pat. No. 11/368,007, are incorporated into the present invention as a part of the present invention.

### FIELD OF THE INVENTION

The present invention relates to toolboxes, and in particular to a toolbox with at least one preview window, in that the user can view the objects in the toolbox.

### BACKGROUND OF THE INVENTION

In the prior art, a tool room is used to store working tools. However the tool room is inconvenient for the workers because the workers must run between the tool room and working places. Thereby toolbox is developed for improving the defects of the tool rooms. Initially, the toolbox has only one receiving space. However this is inconvenient for receiving a plurality of tools and thus a plurality of spacers is used to space the receiving spaces into a plurality of sub-spaces. The tools can be classified and stored in various spaces as desired.

However the prior art toolbox has a defect, that is, the tools in the toolbox cannot be viewed if the drawers are not opened. Thereby the users cannot know the tools stored in the drawer if the drawer is not pulled out. The user must open the drawer one by one for finding a tool, but this is inconvenient in working.

### SUMMARY OF THE INVENTION

Accordingly, the primary object of the present invention is to provide a toolbox with at least one preview window, in that the user can view the objects in the toolbox.

To achieve above objects, the present invention provides a toolbox with at least one preview window. The toolbox comprises a body having a receiving portion for receiving at least one tool; and at least one preview window for viewing objects in the receiving portion. The preview window can be installed at a front plate of a drawer or a lateral surface of the body or a top surface of the body. The receiving portion may be a single space or a plurality of sub-spaces which are spaced by at least one spacer. A bottom of the body has at least one wheel. The user can pull the drawer by inserting a hand into the slot.

The various objects and advantages of the present invention will be more readily understood from the following detailed description when read in conjunction with the appended drawing.

### BRIEF DESCRIPTION OF THE DRAWINGS

FIG. 1 is a perspective view of the first embodiment of the toolbox with at least one preview window of the present invention.

FIG. 2 is a perspective view of the second embodiment of the toolbox with at least one preview window of the present invention.

FIG. 3 is a perspective view of the third embodiment of the toolbox with at least one preview window of the present invention.

FIG. 4 is a perspective view of the fourth embodiment of the toolbox with at least one preview window of the present invention.

### DETAILED DESCRIPTION OF THE INVENTION

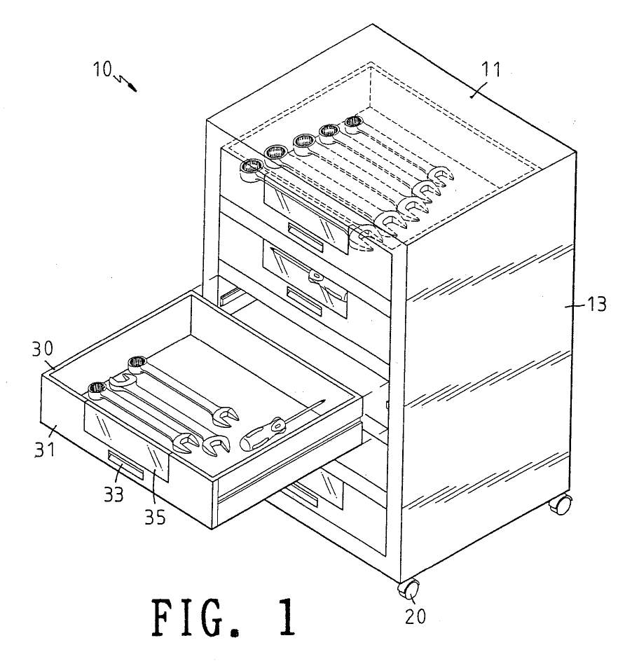

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims. Referring to FIG. 1, the present invention is illustrated. The body 10 of the present invention is a long cubic body. The interior of the body 10 has a receiving portion. A plurality of spacers serves to space the receiving portion into a plurality of sub-spaces.

Referring to FIG. 1, a preferred embodiment of the present invention is illustrated. The present invention has the following elements.

At least one wheel 20 is installed at a bottom end of the body 10.

At least one drawer 30 has a front plate 31. A lower portion of the front plate 31 is formed with a slot 33. The user can pull the drawer 30 by inserting a hand into the slot 33. An upper portion of the front plate 31 is installed with an oblong preview window 35. Users can view the objects in the drawer 30 by seeing through the preview window 35.

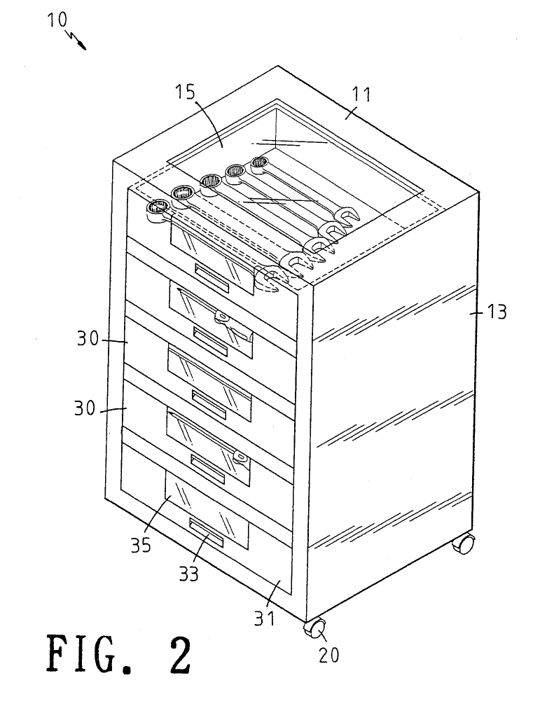

Referring to FIG. 2, the second embodiment of the present invention is illustrated. Those identical to the first embodiment will not be described. Only those differences are described. A top surface portion 11 of the body 10 is installed with a preview window 15 which may occupy a part or whole surface of the top surface portion 11. The user can view of the objects in the body 10 by seeing through the preview window 15.

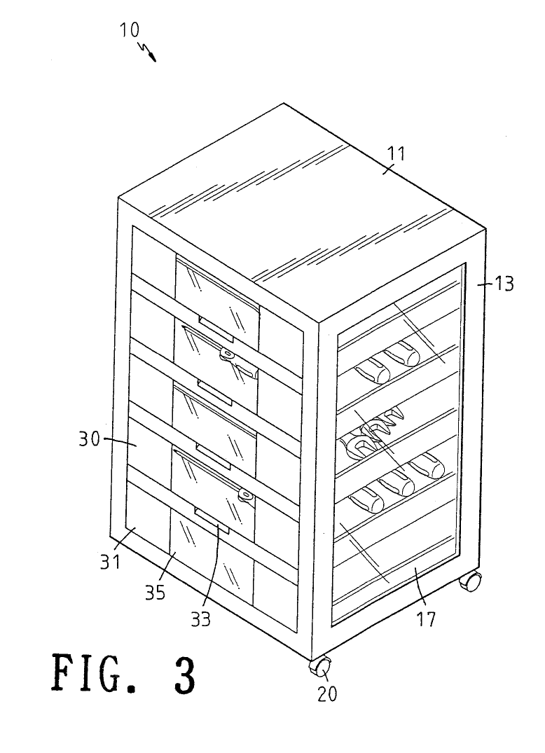

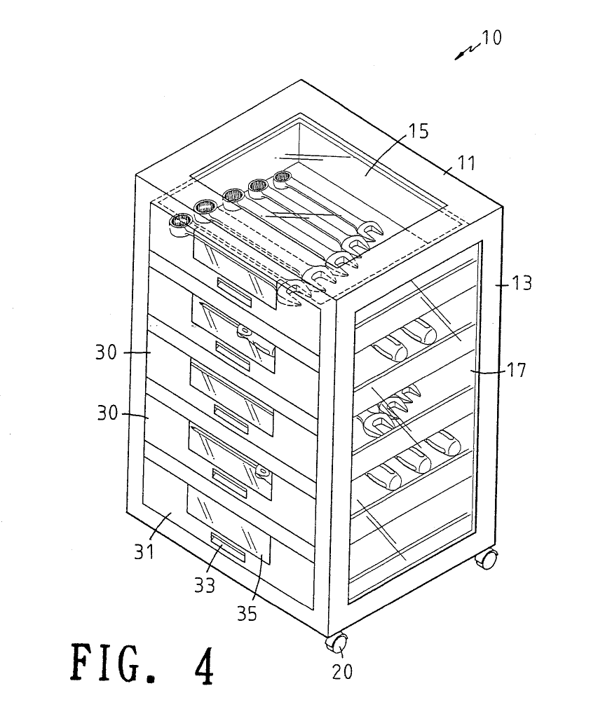

Referring to FIG. 3, the third embodiment of the present invention is illustrated. Those identical to the first embodiment will not be described. Only those differences are described. In this embodiment, the lateral surface portion 13 of the body 10 is formed with a preview window 17. However the top surface portion 11 of the body 10 can still be installed with a preview window 15, as shown in FIG. 4. The user can view the objects in the body 10 by seeing through the preview window 15 or preview window 17.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A toolbox with at least one preview window comprising:
a body having a receiving portion for receiving at least one tool; and
at least one preview window for viewing objects in the receiving portion.

2. The toolbox with at least one preview window as claimed in claim 1, wherein a plurality of preview windows are installed to the body.

3. The toolbox with at least one preview window as claimed in claim 1, wherein the at least one preview window is installed at a top surface of the body.

4. The toolbox with at least one preview window as claimed in claim 1, wherein the at least one preview window is installed at a lateral surface of the body.

5. The toolbox with at least one preview window as claimed in claim 1, wherein the receiving portion is a single space.

6. The toolbox with at least one preview window as claimed in claim 1, wherein at least one spacer serves to space the receiving portion into at least two sub-spaces.

7. The toolbox with at least one preview window as claimed in claim 1, wherein the single space is installed with a drawer.

8. The toolbox with at least one preview window as claimed in claim 1, wherein each sub-space is installed with a drawer.

9. The toolbox with at least one preview window as claimed in claim 7, each drawer is installed with the preview window.

10. The toolbox with at least one preview window as claimed in claim 8, wherein each drawer is installed with a respective one of the at least one preview window.

11. The toolbox with at least one preview window as claimed in claim 1, wherein a bottom of the body has at least one wheel.

12. A toolbox with preview windows, comprising:
a body;
at least one wheel being installed at a bottom end of the body.
a plurality of drawers arranged with one at a top of another one and each drawer having a front plate; a lower portion of the front plate being formed with a slot;
a first preview window being installed at an upper portion of the front plate; wherein a user can pull the drawer by inserting a hand into the slot;
a second preview window formed at a top surface portion of the body; and
a third preview window formed at one lateral surface of the body.

13. The toolbox with preview windows as claimed in claim 12, wherein the first preview window has a rectangular shape and is at an upper middle portion of the front plate and the slot is formed below the first preview window.
